(19) United States
(12) Patent Application Publication
(10) Pub. No.: US 2025/0155367 A1
(43) Pub. Date: May 15, 2025

(54) SPECTROMETER AND METHOD OF DISPLAYING SPECTRAL MEASUREMENT RESULTS

(71) Applicant: SEIKO EPSON CORPORATION, Tokyo (JP)

(72) Inventor: Ryohei KURI, MINOWA-MACHI (JP)

(21) Appl. No.: 18/946,180

(22) Filed: Nov. 13, 2024

(30) Foreign Application Priority Data
Nov. 14, 2023 (JP) 2023-193974

(51) Int. Cl. G01N 21/31

(52) U.S. Cl. CPC G01N 21/31; G01N 2201/021

(57) ABSTRACT

The spectrometer includes a spectroscopic measurement section configured to perform multi-angle spectroscopic measurements on a measurement surface of an object and acquire multi-angle spectroscopic images and an FI value processing section that calculates an FI value for each region of the multi-angle spectroscopic images and generates FI value distribution information indicating a distribution of the FI values.

### CROSS-REFERENCE TO RELATED APPLICATIONS

The present application is based on, and claims priority from JP Application Serial Number 2023-193974, filed Nov. 14, 2023, the disclosure of which is hereby incorporated by reference herein in its entirety.

### BACKGROUND OF THE INVENTION

### 1. Technical Field

The present disclosure relates to a spectrometer and a method of displaying spectral measurement results.

### 2. Related Art

A metallic paint used for painting an automobile or the like contains a flake shaped pigment called a bright pigment and exhibits a metallic feel. In quality control of such metallic painting, it is required to accurately evaluate the distribution state of the metallic feel, that is, the degree of unevenness of the metallic feel.

For example, JP-A-2023-80722 discloses the use of an FI value to represent the degree of flip-flop of a filler-containing coating film. The FI value is calculated from the brightness index L*15°, the brightness index L*45°, and the brightness index L*110° measured by a multi-angle colorimeter. The brightness index L*15°, the brightness index L*45°, and the brightness index L*110° are the brightness indexes L* at light receiving angle is 15°, light receiving angle is 45°, and light receiving angle is 110° when light is incident on the surface of the coating film at an incident angle of 45°.

In the multi-angle colorimeter described in JP-A-2023-80722, it is possible to measure the FI value of the measurement surface, but it is difficult to easily evaluate the distribution state of the metallic feel on the measurement surface.

### SUMMARY OF THE INVENTION

The spectrometer according to the present disclosure includes
a spectroscopic measurement section configured to perform multi-angle spectroscopic measurements on a measurement surface of an object and acquire multi-angle spectroscopic images and an FI value processing section that calculates an FI value for each region of the multi-angle spectroscopic images and generates FI value distribution information indicating a distribution of the FI values.

A method of displaying spectral measurement results, according to the application example of present disclosure includes
sequentially irradiating a measurement surface of an object with light from a plurality of different directions, sequentially imaging the measurement surface irradiated with the light by spectrally dispersing the light with a spectrographic camera, and acquiring multi-angle spectroscopic images;
calculating an FI value of the multi-angle spectroscopic images for each region and generating FI value distribution information indicating a distribution of the FI value; and visualizing and displaying the FI value distribution information.

A method of displaying spectral measurement results, according to the application example of present disclosure includes
sequentially irradiating a measurement surface of an object with light from a plurality of different directions, sequentially imaging the measurement surface irradiated with the light by spectrally dispersing the light with a spectrographic camera, and acquiring first multi-angle spectroscopic images;
rotating a relative orientation of the object with respect to an irradiation direction of the light and a position of the spectrographic camera by 180° in a plane having the measurement surface;
sequentially irradiating the measurement surface of the object after rotation with light from a plurality of different directions, sequentially imaging the measurement surface irradiated with the light by spectrally dispersing the light with the spectrographic camera, and acquiring second multi-angle spectroscopic images;
calculating a first FI value for each region of the first multi-angle spectroscopic images and generating first FI value distribution information;
calculating a second FI value for each of the region of the second multi-angle spectroscopic images and generating second FI value distribution information;
calculating differences between the first FI value and the second FI value for each region and generating FI value distribution difference information indicating a distribution of the differences; and
visualizing and displaying the FI value distribution difference information.

### BRIEF DESCRIPTION OF DRAWINGS

FIG. 1 is a schematic view showing the spectrometer according to the first embodiment.

FIG. 2 is a functional block diagram of the spectrometer shown in FIG. 1.

FIG. 3 is a diagram illustrating an example of a hardware configuration for realizing the functions of the functional sections included in the spectrometer of FIG. 2.

FIG. 4 is a flowchart showing the configuration of the method of displaying spectral measurement results according to the first embodiment.

FIG. 5 is an example of a display screen including a preview image displayed in the preview image acquisition step.

FIG. 6 is an example of a display screen including an FI image displayed in the FI value distribution information display step.

FIG. 7 is a flowchart showing a configuration of the method of displaying spectral measurement results according to the second embodiment.

FIG. 8 is a schematic diagram showing the concept of the FI value distribution difference information generation step in FIG. 7.

FIG. 9 is a schematic view showing a spectrometer according to the third embodiment.

FIG. 10 is a functional block diagram of the spectrometer shown in FIG. 9.

FIG. 11 is an example of a display screen displayed in an FI value distribution information display step included in the method of displaying spectral measurement results according to the fourth embodiment.

FIG. 12 is a graph showing an example of the result of the data comparison processing.

### DETAILED DESCRIPTION OF THE INVENTION

Hereinafter, a spectrometer and a method of displaying spectral measurement results according to the present disclosure will be described in detail based on embodiments illustrated in the accompanying drawings.

### 1. First Embodiment

First, a spectrometer and a method of displaying spectral measurement results according to a first embodiment will be described.

### 1.1. Spectrometer

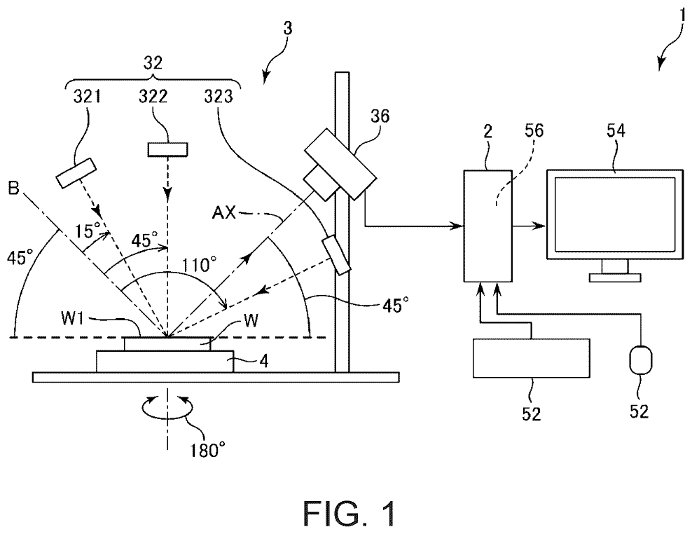

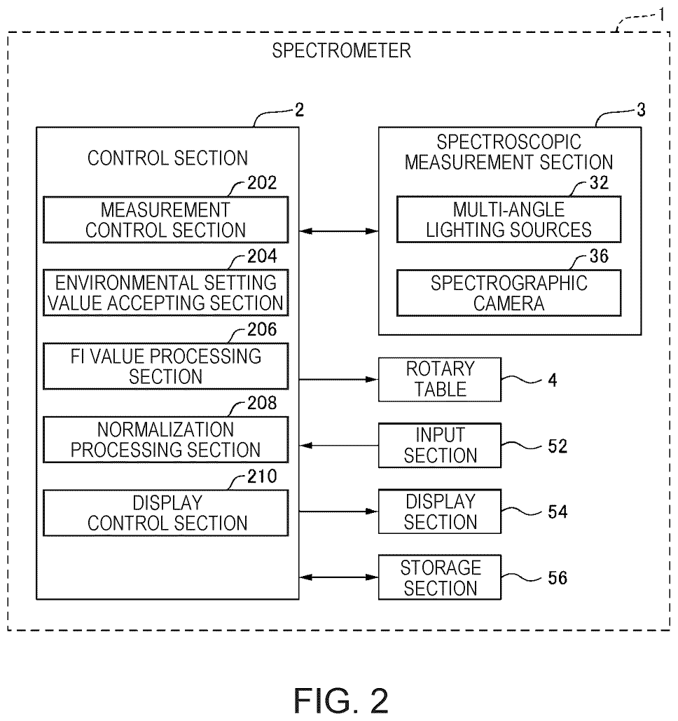

FIG. 1 is a schematic view showing a spectrometer 1 according to the first embodiment. FIG. 2 is a functional block diagram of the spectrometer 1 shown in FIG. 1.

1.1.1. Overview of apparatus

The spectrometer 1 illustrated in FIG. 1 is an apparatus that evaluates the distribution state of metallic feel with respect to the measurement surface W1 of an object W. In a case where the object W includes a luster material with optical anisotropy, mainly the brightness greatly changes according to the orientation state and the light receiving state of the luster material, the angle at which the reflection light is observed, and the like. In general, when the light reflection surface of the luster material is arranged in parallel to the measurement surface W1 and the light reflection on the luster material becomes similar to specular reflection, a glossy feeling is conspicuous and an appearance having a metallic feel is obtained. By evaluating the distribution state of the metallic feel in the spectrometer 1, the efficiency of the inspection, and the like, of measurement surface W1 is improved. Examples of the luster material include flake pigments such as aluminum flake pigment and pearl mica flake pigment, or the like.

The spectrometer 1 illustrated in FIG. 1 includes a control section 2, a spectroscopic measurement section 3, a rotary table 4, an input section 52, a display section 54, and a storage section 56.

The control section 2 controls the operation of the spectroscopic measurement section 3. The control section 2 has a function of receiving an input from the input section 52, a function of displaying information on the display section 54, a function of writing and reading information to and from the storage section 56, and the like.

The spectroscopic measurement section 3 performs multi-angle spectroscopic measurements on the measurement surface W1 to acquire a spectroscopic image. Spectroscopic measurement refers to obtaining a spectrum (spectral data) by spectrally dispersing reflection light from the measurement surface W1 for each region. Spectroscopic image refers to a data cube in which images (planar images) for each spectral wavelength are collected. Note that the spectroscopic image has spectral data for each of the above-described region, and the “region” in “each region” may be a group of a plurality of pixels but is preferably one pixel. That is, the spectroscopic image preferably has spectral data for each pixel. By this, it is possible to easily evaluate the distribution state of the metallic feel with high positional accuracy.

The spectroscopic measurement section 3 includes a multi-angle lighting source 32 and a spectrographic camera 36.

The multi-angle lighting source 32 includes a plurality of lighting sources 321, 322, and 323, and irradiates the measurement surface W1 with light from directions different from each other. The light emitted from the multi-angle lighting source 32 is reflected by the measurement surface W1 and enters the spectrographic camera 36 as reflection light. The lighting sources 321, 322, and 323 are configured to emit light in a mutually exclusive manner. Therefore, a spectroscopic image set (multi-angle spectroscopic images) in which the incident angles of the illumination light are different is obtained by using the spectrographic camera 36 to capture images (performing multi-angle spectral measurement) of each reflection light of the light sequentially irradiated from different directions.

The rotary table 4 is a table on which the object W is placed and rotated in a plane including the measurement surface W1. By using the rotary table 4, the object W can be easily rotated. The control section 2 may have a function of controlling the operation of the rotary table 4.

The input section 52 receives an input operation by a user of the spectrometer 1. The input information received by the input section 52 is transmitted to the control section 2.

The display section 54 displays information output from the control section 2. By this, the user of the spectrometer 1 can visually check the displayed information.

The storage section 56 stores program, data, set value, and the like necessary for the operation of the control section 2. The storage section 56 corresponds writing data or the like and reading a program or the like from the control section 2.

### 1.1.2. Control Section

The control section 2 illustrated in FIG. 2 includes, as functional sections, a measurement control section 202, an environmental setting value accepting section 204, an FI value processing section 206, a normalization processing section 208, and a display control section 210.

The measurement control section 202 controls the operation of the spectroscopic measurement section 3 and causes the spectroscopic measurement section 3 to acquire the multi-angle spectroscopic images or the preview image. The measurement control section 202 stores the acquired multi-angle spectroscopic images and preview image in the storage section 56. The multi-angle spectroscopic images and the preview image are acquired by, for example, an input operation via the input section 52.

The environmental setting value accepting section 204 receives an environmental setting value used when an L-image, an a-image, or a b-image is generated from multi-angle spectroscopic images. The L-image is planar distribution data of the L-value. The a-image and the b-image are plane distribution data of the a-value and the b-value. As used herein, the term “L-value” refers to an L* value representing brightness in the L*a*b* color space standardized in 1976 by the Commission Internationale de l'Eclairage (CIE). In the present specification, the “a-value” refers to an a* value representing chromaticity in the L*a*b* color space. Further, as used herein, the term “b-value” refers to a b* value representing chromaticity in the L*a*b* color space. Examples of the environmental setting values include a color-matching function and a lighting source, and either one or both can be used. In the following description, at least one of the L-value, the a-value, and the b-value is also referred to as a “Lab value”. Further, at least one of the L-image, the a-image, and the b-image is also referred to as a “Lab image”.

The color-matching function is a function representing spectral sensitivity to the human eye. Examples of the color-matching function include a color-matching function of a CIE1931 color measurement standard observer (2-degree visual field color-matching function) and a color-matching function of a CIE1964 color measurement auxiliary standard observer (10-degree visual field color-matching function).

The lighting source is a standard light source defined to reproduce an illumination environment. Examples of the lighting source include a CIE standard lighting source D50, a CIE standard lighting source D65, an incandescent light A, a standard illuminant C, a cold white fluorescent light CWF, a fluorescent lamp TL84 and the like.

In the present embodiment, the control section 2 is configured to generate the Lab image defined in the L*a*b* color space from the multi-angle spectroscopic images but may be configured to generate an image defined in another color space. As another color space, for example, an L*C*h color space or the like is exemplified.

The FI value processing section 206 generates a Lab image based on the multi-angle spectroscopic images and the environmental setting value. Specifically, first, the L-value, the a-value, and the b-value are extracted for each pixel from the spectral data of each pixel included in the multi-angle spectroscopic images based on the environmental setting value. By this, a multi-angle Lab image representing a distribution state on the plane of Lab values is obtained.

Next, an FI value for each pixel is calculated from the multi-angle Lab values. The FI value means a flop index value, and is an index value quantitatively representing a metallic feel. Various definitions are known for the FI value, but as long as the index value quantitatively represents a metallic feel, it may be an index value according to any definition. Therefore, various calculation formulas may be used to calculate the FI value, and the following equation is used here, but the present disclosure is not limited thereto.

$$FI = 2.69 \times \frac{{( L * 15 ° - L * 110 ° )}^{1.11}}{L * 45 {°}^{0.86}} \qquad Equation 1$$

In the above equation 1, FI means the FI value. L*15° is, as will be described later, an L-value obtained from a spectroscopic image acquired in a state where light is emitted from a direction in which a deviation angle from the standard angle is 15°. L*45° is an L-value obtained from a spectroscopic image acquired in a state of being irradiated with light from a direction where a deviation angle from a standard angle is 45°. L*110° is an L-value obtained from a spectroscopic image acquired in a state where light is emitted from a direction in which a deviation angle from the standard angle is 110°. L*15° is the L-value extracted from the reflection light of the light irradiated from the highlight angle, and mainly contributes to the improvement of the metallic feel. On the other hand, L*110° is the L-value extracted from the reflection light of the light irradiated from the shade angle and is unlikely to mainly contribute to the improvement of the metallic feel. L*45° is the L-value extracted from the reflection light of the light irradiated from the normal line direction of the measurement surface W1.

Since the above equation 1 is calculated based on the L-value, it is a formula for calculating the FI value defined by the brightness. The larger the FI value defined by the above equation 1 is, the higher the metallic feel can be quantitatively evaluated. By calculating the FI value for each pixel, FI value distribution information representing the distribution of the FI values is generated.

The above equation 1 may be an equation in which the L-value is replaced with the a-value or the b-value. In this case, the FI value defined by the chromaticity instead of the brightness can be calculated. By this, it is possible to quantitatively evaluate not only the metallic feel but also a pearl feel (metallic feel to which a chromaticity element is also added). The pearl feel is a characteristic in which the chromaticity also changes according to the orientation state of the luster material, the light receiving state, the angle at which the reflection light is observed, and the like.

Next, the FI value is converted into luminance to generate an FI image. For example, in a case where the FI image is a bitmap image of 256 grayscale gradation, the minimum value of the calculated FI value may correspond to the luminance 0, and the maximum value of the FI value may correspond to the luminance 255. By this, an FI image that can be visually checked by a human is obtained. Since the FI value is visualized in the FI image, it is useful for the user to intuitively understand the FI value. Note that the FI image is an example of visualized FI value distribution information, and the visualization format is not limited to this. Further, the method of associating the FI value and the luminance in the FI image is not limited to the above-described method.

The FI value processing section 206 performs various kinds of analysis processing, such as statistical processing, data comparison processing, and pass/fail determination processing, on the FI image. Examples of the statistical processing include processing for calculating a statistical value such as a minimum value, a maximum value, an average value, or a variance value. Examples of the data comparison process include a process of comparing the FI image generated from the multi-angle spectroscopic images with the reference data. The pass/fail determination process includes, for example, a process of determining whether or not the processing result of the data comparison process satisfies a pass criterion.

The normalization processing section 208 performs a process of normalizing the correspondence between the FI value and the luminance. This normalization processing is performed based on, for example, the range of the FI value. Note that this range is normally a range from the minimum value to the maximum value of the calculated FI value but may be an arbitrarily designated range.

For example, the normalization processing section 208 may perform processing for determining the above-described range based on the range of the FI value in the two-dimensional region designated by the input section 52. In addition, the normalization processing section 208 may perform a process of determining the above-described range based on a designated value input as text by the input section 52. In present specification, these two dimensional regions and designated values are also referred to as “normalization parameters”.

The display control section 210 displays the FI image and the preview image on the display section 54. The display control section 210 may have, for example, a function of causing the display section 54 to display a graphical user interface (GUI) screen for receiving an input or selection of an environmental setting value, a GUI screen for receiving an input of a normalization parameter, or the like.

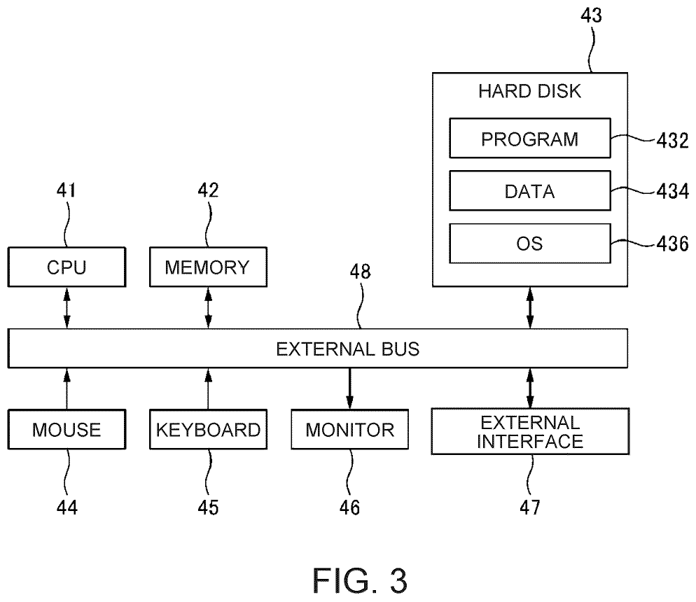

FIG. 3 is a diagram illustrating an example of a hardware configuration for realizing the functions of the functional sections included in the spectrometer 1 of FIG. 2.

The function of each functional section of the spectrometer 1 is realized by, for example, hardware including a CPU 41, a memory 42, a hard disk 43, a mouse 44, a keyboard 45, a monitor 46, an external interface 47, and an external bus 48 illustrated in FIG. 3. Among these, the CPU 41, the memory 42, the hard disk 43, the external interface 47, and the external bus 48 are, for example, configured as a computer.

The CPU 41 is a Central Processing Unit. Examples of the memory 42 include an arbitrary non-volatile storage element (ROM), an arbitrary volatile storage element (RAM), and a detachable external storage element. Examples of the external interface 47 include a digital input/output port such as an Universal Serial Bus (USB), an Ethernet® port, and a video output port. The hard disk 43 stores a program 432, data 434, and OS 436. The program 432 includes a program for realizing the method of displaying spectral measurement results. The data 434 is, for example, multi-angle spectroscopic images, an FI image, an environmental setting value, a normalization parameter, or the like. The OS 436 is an operating system. The hard disk 43 may be, for example, a storage medium such as a flash memory, a Solid State Drive (SSD), or the like. In addition, all or a part of the hardware may be configured by a Field-Programmable Gate Array (FPGA), an Application Specific Integrated Circuit (ASIC), or the like. Further, instead of or in addition to at least one of the mouse 44 and the keyboard 45, for example, a touch panel, a touch pad, a microphone, or the like may be provided.

The program 432 is developed in the memory 42 and executed by the CPU 41. When the CPU 41 executes the program 432, the functions of the above-described functional sections are realized.

The program 432 and the data 434 may be stored in a non-volatile storage medium (computer-readable storage medium). The program 432 and the data 434 may be provided from the outside via a network.

### 1.1.3. Spectroscopic Measurement Section

The spectroscopic measurement section 3 illustrated in FIG. 1 includes the multi-angle lighting source 32 and the spectrographic camera 36. By using these, it is possible to realize the spectrometer 1 capable of more accurately and quickly evaluating the distribution state of the metallic feel of measurement surface W1.

The multi-angle lighting source 32 includes lighting sources 321, 322, and 323. Examples of lighting sources 321, 322, and 323 may include a bar lighting source, a line lighting source, and the like.

The spectrographic camera 36 includes a spectral dispersion section and an imaging element (not illustrated). The spectral dispersion section is an optical element having a function of selecting light in a specific wavelength region from the reflection light. The selected light enters the imaging element. The imaging element is an image sensor that detects a two dimensional distribution of the intensity of incident light. By switching the specific wavelength selected by the spectral dispersion section, the imaging element can capture a two dimensional image with various wavelengths. By this, a spectroscopic image is obtained. The multi-angle spectroscopic images are obtained by acquiring a spectroscopic image for each angle of illumination light. The spectrographic camera 36 may have a function of acquiring, for example, a monochrome image, an RGB image, or the like. Since these images can be acquired in a shorter time than the spectroscopic image, they can be used as preview images, for example.

The spectrographic camera 36 is installed at an angle of 45° from the plane including the measurement surface W1. An angle at which the optical axis AX of the spectrographic camera 36 is regularly reflected by the measurement surface W1 is set as the reference angle B in FIG. 1. The lighting source 321 is installed at an angle rotated by 15° from the reference angle B shown in FIG. 1 to the spectrographic camera 36 side. The lighting source 322 is installed at an angle rotated by 45° from the reference angle B to the spectrographic camera 36 side. The lighting source 323 is installed at an angle rotated 110° from the reference angle B to the spectrographic camera 36 side.

Note that the configuration of the spectroscopic measurement section 3 is not limited to those described above.

### 1.2. Method of Displaying Spectral Measurement Results

Next, the method of displaying spectral measurement results according to the first embodiment will be described.

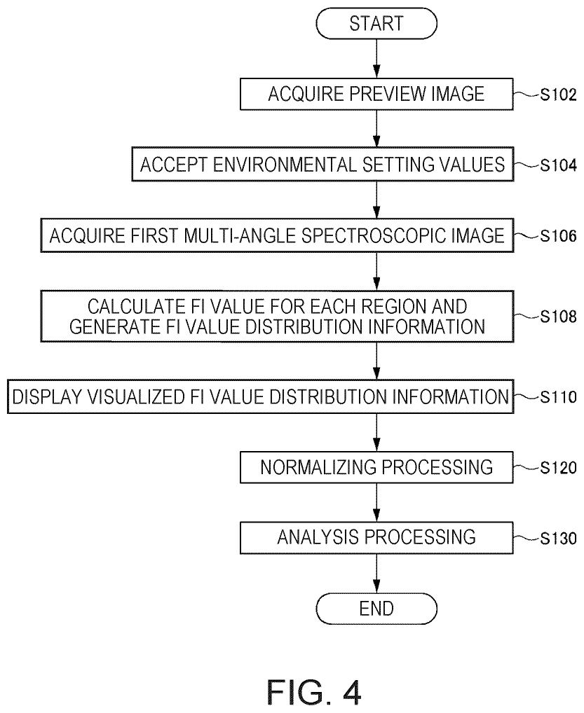

FIG. 4 is a flowchart showing the configuration of the method of displaying spectral measurement results according to the first embodiment. The method of displaying spectral measurement results illustrated in FIG. 4 is performed by, for example, the CPU 41 executing the program 432 and the OS 436. Note that the CPU 41 may be performed by executing only the program 432.

The method of displaying spectral measurement results illustrated in FIG. 4 includes a preview image acquisition step S102, an environmental setting value accepting step S104, a spectroscopic image acquisition step S106, an FI value distribution information generation step S108, an FI value distribution information display step S110, a normalization processing step S120, and an analysis processing step S130.

### 1.2.1. Preview Image Acquisition Step

In a preview image acquisition step S102, preview image acquisition processing and preview image display processing are performed.

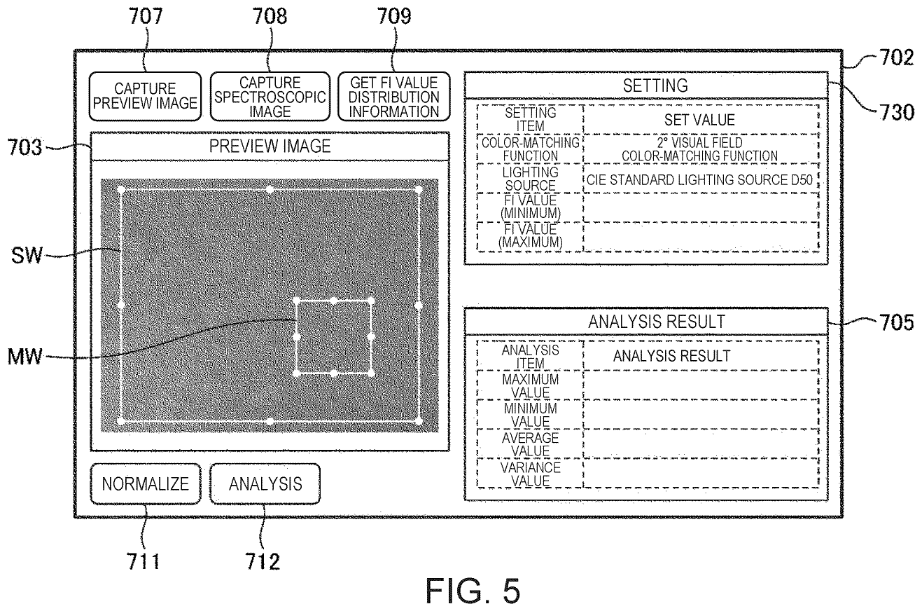

FIG. 5 is an example of a display screen 702 including a preview image 703 displayed in the preview image acquisition step S102. In the present embodiment, the object W is a coating film containing a flake shaped luster material.

The display screen 702 illustrated in FIG. 5 includes the preview image 703, a preview image acquisition button 707, a spectroscopic image acquisition button 708, an FI value distribution information acquisition button 709, a normalization process button 711, and an analysis processing button 712.

The preview image acquisition process is a process in which the measurement control section 202 shown in FIG. 2 controls the operation of the spectroscopic measurement section 3 to acquire the preview image 703 shown in FIG. 5. The preview image display process is a process in which the display control section 210 shown in FIG. 2 causes the display section 54 to display the preview image 703. When the preview image acquisition button 707 shown in FIG. 5 is pressed, a preview image acquisition process and a preview image display process are executed. Since the acquisition time of the preview image 703 is shorter than that of the spectroscopic image, the preview image 703 represents the appearance of the target object W substantially in real time. Therefore, while viewing the preview image 703, the user of the spectrometer 1 can efficiently perform adjustment of the arrangement of the object W, adjustment of the distance between the object W and the spectroscopic measurement section 3, adjustment of the focus, replacement of the lens, adjustment of the spectroscopic measurement section 3, and the like.

### 1.2.2. Environmental Setting Value Accepting Step

In the environmental setting value accepting step S104, accepting processing of an environmental setting value is performed.

The environmental setting value accepting process is a process in which the environmental setting value accepting section 204 illustrated in FIG. 2 receives an environmental setting value. The environmental setting value may be stored in the storage section 56 in advance or may be input via the input section 52.

FIG. 5 includes a setting field 730 for supporting the input of the environmental setting value in the environmental setting value accepting step S104. In the setting field 730 shown in FIG. 5, an input of a set value of each setting item is received. Examples of the setting items include environmental setting values such as a color-matching function and a lighting source, normalization parameters, and various threshold values. These set values are stored in the storage section 56.

### 1.2.3. Spectroscopic Image Acquisition Step

In the spectroscopic image acquisition step S106, spectroscopic image acquisition processing is performed.

The spectroscopic image acquisition process is a process in which the measurement control section 202 shown in FIG. 2 controls the operation of the spectroscopic measurement section 3 to acquire multi-angle spectroscopic images. When the spectroscopic image acquisition button 708 shown in FIG. 5 is pressed, a spectroscopic image acquisition process is executed. The acquired multi-angle spectroscopic images are stored in the storage section 56.

The configuration of the spectroscopic measurement section 3 is suitable for calculating the FI value using the above-described calculation formula. Therefore, the configuration of the spectroscopic measurement section 3 can be appropriately changed according to the definition of the FI value.

### 1.2.4. FI Value Distribution Information Generation Step

In the FI value distribution information generation step S108, the FI value distribution information generation processing is performed.

The FI value distribution information generation process is a process in which the FI value processing section 206 shown in FIG. 2 generates the FI value distribution information based on the multi-angle spectroscopic images and visualizes the FI value distribution information. When the FI value distribution information acquisition button 709 shown in FIG. 5 is pressed, the FI value distribution information generation processing is executed, the FI value is calculated for each pixel, and the FI value distribution information representing the distribution of the FI values is generated. Following the FI value distribution information generation process, an FI value distribution information display process is executed. By this, an FI image, which is an example of visualized FI value distribution information, is generated. The FI image can represent an FI value corresponding to a position on the measurement surface W1. Visualization refers to the process of performing, for example, imaging, graphing, patterning, or the like on the FI values.

### 1.2.5. FI Value Distribution Information Display Step

In an FI value distribution information display step S110, FI value distribution information display processing is performed.

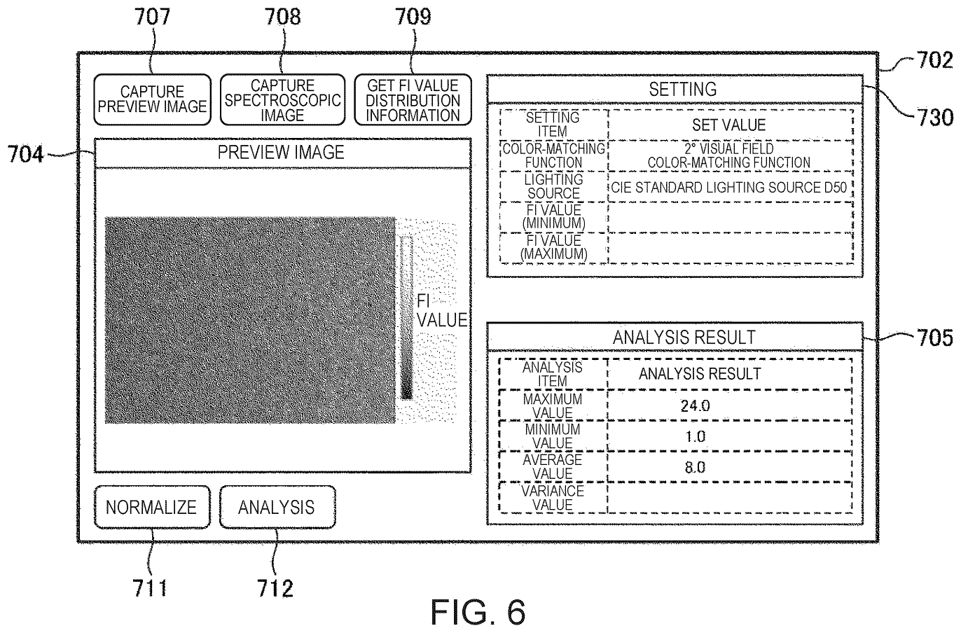

FIG. 6 is an example of the display screen 702 including a FI image 704 displayed in the FI value distribution information display step S110.

The FI value distribution information display process is a process in which the display control section 210 shown in FIG. 2 displays the FI image 704 on the display section 54. In the FI image 704 shown in FIG. 6, the FI value quantitatively representing the metallic feel caused by the luster material is converted into the luminance. Therefore, it can be estimated that the points with high luminance dispersed in the FI image 704 are due to the presence of luster material. By displaying the FI image 704 in this way, it becomes easy for the user to intuitively understand the distribution state of the metallic feel on the measurement surface W1. As a result, it is possible to accurately evaluate the degree of unevenness of the metallic feel on the measurement surface W1. In the FI image 704, the FI value of each pixel (each region) is converted into luminance and represented. In other words, the FI image 704 can represent the FI value corresponding to the position on the measurement surface W1. Therefore, it is possible to easily evaluate the distribution state of the metallic feel with high positional accuracy.

### 1.2.6. Normalization Processing Step

In normalization processing step S120, normalization processing is performed. This step can be performed as necessary, for example, when the luminance of the FI image 704 generated by the FI value distribution information display process is not appropriate.

The normalization process is a process in which the normalization processing section 208 illustrated in FIG. 2 normalizes the correspondence relationship between the FI value and the luminance based on the normalization parameter. When the normalization process button 711 shown in FIG. 5 is pressed, normalization processing is executed on the FI image 704. By this, understanding of the distribution state of the metallic feel by the FI image 704 is improved.

The input method of the normalization parameter is not particularly limited, but in the example shown in FIG. 5, the normalization parameter is determined by designating a two dimensional region in the preview image 703. When the preview image acquisition button 707 shown in FIG. 5 is pressed, the search window SW and the model window MW shown in FIG. 5 are displayed together with the preview image 703. The search window SW is used to designate a two-dimensional region in which multi-angle spectroscopic images are acquired by being enlarged or reduced via the input section 52. The model window MW is used to designate a two-dimensional region for calculating the FI value by being enlarged or reduced via the input section 52. Specifically, the minimum value and the maximum value of the FI values included in the model window MW are assigned to the minimum value and the maximum value of the luminance. By this, the normalization process can be performed as intended.

### 1.2.7. Analysis Processing Step

In analysis processing step S130, analysis processing is performed.

The analysis processing includes statistical processing, data comparison processing, pass/fail determination processing, and the like performed by the FI value processing section 206 shown in FIG. 2. When the analysis processing button 712 shown in FIG. 5 is pressed, the analysis processing is executed on the FI value distribution information.

FIG. 6 includes a result of the statistical processing (analysis result 705) as an example. In the example of FIG. 6, a maximum value, a minimum value, an average value, and a variance value are shown as the analysis items.

By performing such analysis processing, the FI value distribution information can be evaluated more accurately. By this, it is possible to more accurately perform the inspection or the like of the measurement surface W1.

In the pass/fail determination process, for example, the pass/fail determination of the object W can be performed based on whether or not the difference between the maximum value and the minimum value or the variance value is within a threshold value.

The method of displaying spectral measurement results according to the first embodiment has been described above, but some of the steps described above may be omitted or replaced with steps having the same configuration. The order of the steps may be changed.

### 2. Second Embodiment

Next, a method of displaying spectral measurement results according to a second embodiment will be described.

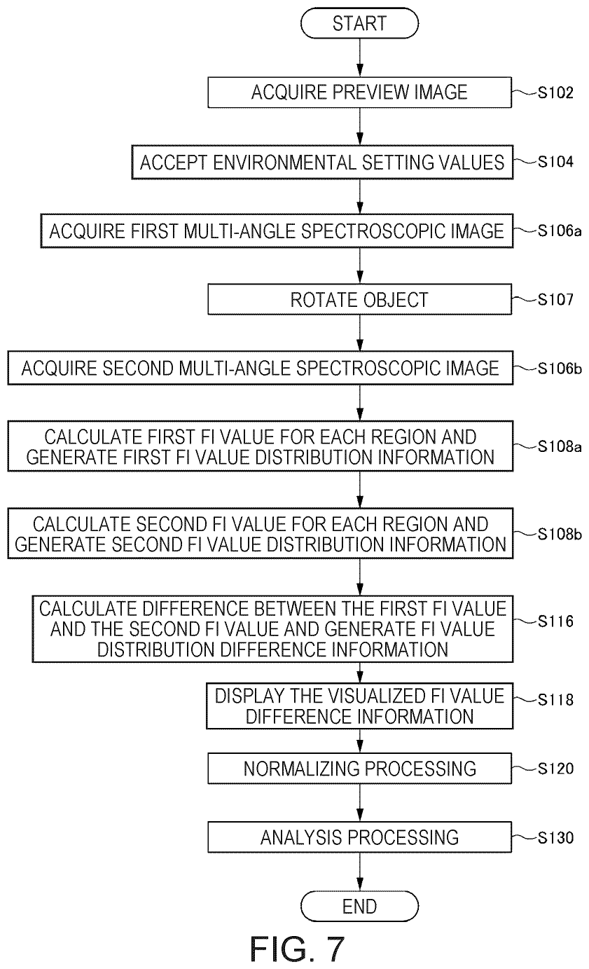

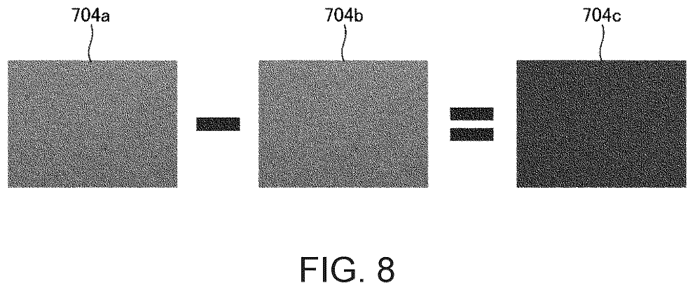

FIG. 7 is a flowchart showing a configuration of the method of displaying spectral measurement results according to the second embodiment. FIG. 8 is a schematic diagram showing the concept of the FI value distribution difference information generation step S116 in FIG. 7.

Hereinafter, the second embodiment will be described. In the following description, differences from the first embodiment will be mainly described, and the description of the same matters will be omitted. In FIG. 7, the same components as those in FIG. 4 are denoted by the same reference numerals.

The second embodiment is the same as the first embodiment except that the second embodiment includes a process of obtaining a difference between sets of FI value distribution information acquired by changing the direction of the object W.

The method of displaying spectral measurement results shown in FIG. 7 includes a preview image acquisition step S102, an environmental setting value accepting step S104, a first spectroscopic image acquisition step S106a, an object rotation step S107, a second spectroscopic image acquisition step S106b, a first FI value distribution information generation step S108a, a second FI value distribution information generation step S108b, a FI value distribution difference information generation step S116, a FI value distribution difference information display step S118, a normalization processing step S120, and an analysis processing step S130.

### 2.1. Preview Image Acquisition Step

In a preview image acquisition step S102, preview image acquisition processing and preview image display processing are performed.

### 2.2. Environmental Setting Value Accepting Step

In the environmental setting value accepting step S104, accepting processing of an environmental setting value is performed.

### 2.3. First Spectroscopic Image Acquisition Step

In the first spectroscopic image acquisition step S106a, a first spectroscopic image acquisition process is performed.

The first spectroscopic image acquisition process is a process of obtaining first multi-angle spectroscopic images in the same manner as in the spectroscopic image acquisition step S106 of the first embodiment. The acquired first multi-angle spectroscopic images are stored in the storage section 56.

### 2.4. Object Rotation Step

In an object rotation step S107, object rotation processing is performed.

The object rotation process is a process in which the control section 2 controls the operation of the rotary table 4 to rotate the orientation of the object W by 180° in a plane including the measurement surface W1. Specifically, in the object rotation processing, the irradiation direction of the light irradiated from the multi-angle lighting source 32 and the relative orientation of the object W with respect to the position of the spectrographic camera 36 is rotated by 180°. Therefore, instead of the process of rotating the object W by the operation of the rotary table 4, a process of rotating the multi-angle lighting source 32 and the spectrographic camera 36 may be executed.

### 2.5. Second Spectroscopic Image Acquisition Step

In the second spectroscopic image acquisition step S106b, a second spectroscopic image acquisition process is performed.

The second spectroscopic image acquisition process is a process of obtaining second multi-angle spectroscopic images for the measurement surface W1 in the same manner as the spectroscopic image acquisition step S106 of the first embodiment after the object W is rotated. The acquired second multi-angle spectroscopic images are stored in the storage section 56.

### 2.6. First FI Value Distribution Information Generation Step

In the first FI value distribution information generation step S108a, the first FI value distribution information generation process is performed.

The first FI value distribution information generation process is a process of generating the first FI value distribution information based on the first multi-angle spectroscopic images in the same manner as in the FI value distribution information generation process of the first embodiment. To be specific, the first FI value is calculated for each pixel of the first multi-angle spectroscopic images, and the first FI value distribution information representing the distribution of the first FI value is obtained. A first FI image 704a shown in FIG. 8 is an example of an image obtained by visualizing the first FI value distribution information. Since the first FI image 704a is displayed on the display section 54, it is easy to intuitively understand the distribution state of the metallic feel on the measurement surface W1. As a result, it is possible to accurately evaluate the degree of unevenness of the metallic feel on the measurement surface W1.

### 2.7. Second FI Value Distribution Information Generation Step

In the second FI value distribution information generation step S108b, the second FI value distribution information generation process is performed.

The second FI value distribution information generation process is a process of generating the second FI value distribution information based on the second multi-angle spectroscopic images in the same manner as in the first FI value distribution information generation process. To be specific, the second FI value is calculated for each pixel of the second multi-angle spectroscopic images, and the second FI value distribution information representing the distribution of the second FI values is obtained. A second FI image 704b illustrated in FIG. 8 is an example of an image obtained by visualizing the second FI value distribution information. Since the second FI image 704b is displayed on the display section 54, it is easy to intuitively understand the distribution state of the metallic feel on the measurement surface W1 when viewed from an angle different from the above case. As a result, it is possible to accurately evaluate the degree of unevenness of the metallic feel on the measurement surface W1.

### 2.8. FI Value Distribution Difference Information Generation Step

In the FI value distribution difference information generation step S116, the FI value distribution difference information generation processing is performed.

The FI value distribution difference information generation process is a process of calculating the difference between the first FI value and the second FI value for each pixel and generating FI value distribution difference information representing the distribution of the difference. A FI difference image 704c shown in FIG. 8 is an example of an image obtained by visualizing FI value distribution difference information.

The FI value distribution difference information represents the distribution of the FI value difference that is the difference between the first FI value and the second FI value. The difference is an absolute value of the difference between the first FI value and the second FI value. The FI value difference approaches zero when the first FI value and the second FI value are close to each other. In this case, the FI difference image 704c is a dark image with low luminance, as shown in FIG. 8. On the other hand, when the FI value difference is a large value, the FI difference image has high luminance and is a bright image.

The first FI value and the second FI value are values calculated by acquiring multi-angle spectroscopic images of the same measurement surface W1 before and after rotation. It is possible to estimate the orientation state of the luster material included in the object W by obtaining the difference therebetween. For example, when the light reflection surface of the luster material is oriented parallel to the measurement surface W1, the reflection angle of light hardly changes before and after the rotation. Therefore, the first FI value and the second FI value are close to each other, and the FI value difference approaches zero. On the other hand, when the light reflection surface of the luster material is inclined with respect to the measurement surface W1, the reflection angle of light changes before and after the rotation. Therefore, the FI value difference becomes a large value. Therefore, if the FI value distribution difference information can be acquired, the distribution of the orientation state of the luster material can be accurately evaluated.

Depending on the inclination direction of the luster material, the FI value may be obtained not only after the rotation at 180° but also after the rotation at another rotation angle, for example, 90° or 270°, and the FI value difference before and after the rotation may be calculated. By this, it possible to more accurately evaluate the distribution of the orientation state of the luster material.

### 2.9. Normalization Processing Step

In normalization processing step S120, normalization processing is performed. By this, it possible to generate the first FI image 704a, the second FI image 704b, and the FI difference image 704c with more appropriate brightness.

### 2.10. Analysis Processing Step

In analysis processing step S130, analysis processing is performed. By this, it possible to more accurately evaluate the first FI value distribution information, the second FI value distribution information, and the FI value distribution difference information. In particular, by performing analysis processing on the FI value distribution difference information, it is possible to evaluate the number, distribution, and the like of luster materials inclined in a specific direction. By this, it is possible to efficiently perform not only the inspection of the object W but also the review of the manufacturing condition, the sorting of the object W, and the like.

Also, in the second embodiment as described above, the same effects as in the first embodiment can be obtained.

Note that some of the steps described above may be omitted or may be replaced with steps having the same configuration. The order of the steps may be changed.

### 3. Third Embodiment

Next, a spectrometer and a method of displaying spectral measurement results according to a third embodiment will be described.

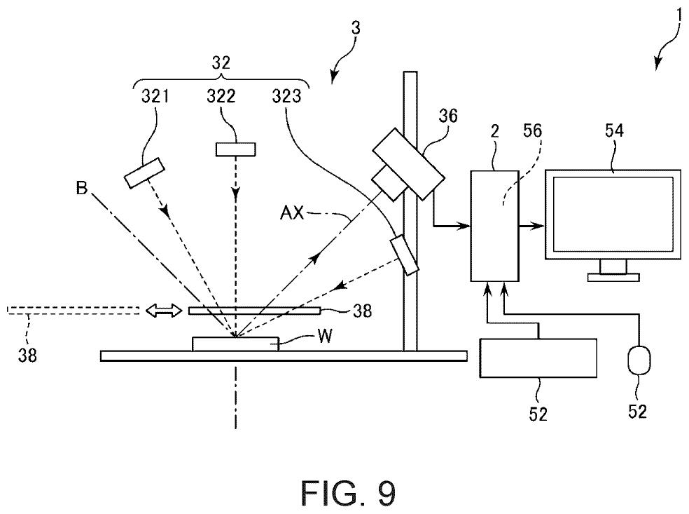

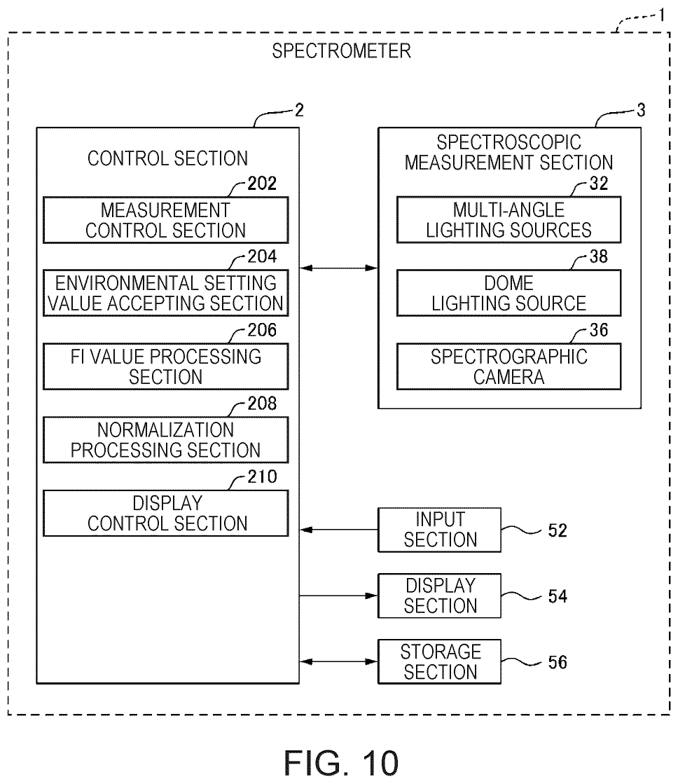

FIG. 9 is a schematic view showing the spectrometer 1 according to the third embodiment. FIG. 10 is a functional block diagram of the spectrometer 1 shown in FIG. 9.

Hereinafter, the third embodiment will be described. In the following description, differences from the first and second embodiment will be mainly described, and the description of the same matters will be omitted. In FIGS. 9 and 10, the same components as those in FIGS. 1 and 2 are denoted by the same reference numerals.

### 3.1. Spectrometer

First, the spectrometer 1 according to the third embodiment will be described.

The spectrometer 1 according to the third embodiment is the same as the spectrometer 1 according to the first embodiment except that the spectroscopic measurement section 3 further includes a dome lighting source 38.

The spectrometer 1 shown in FIGS. 9 and 10 is the same as the spectrometer 1 shown in FIGS. 1 and 2 except that the rotary table 4 is omitted and the dome lighting source 38 is added.

The dome lighting source 38 shown in FIG. 9 is a lighting source device which has lighting sources arranged annularly and can perform epi-illumination by using a light guide plate (not shown). Since it has translucency, a spectroscopic image can be acquired through the dome lighting source 38. The light emitted from the dome lighting source 38 enters the measurement surface W1 from a plurality of directions. Therefore, in a state where light is irradiated from the dome lighting source 38, when the light reflection surface of the luster material is oriented parallel to the measurement surface W1, reflection light is obtained at a constant intensity. On the other hand, when the light reflection surface of the luster material is not parallel to the measurement surface W1, the intensity of the reflection light decreases. Therefore, by acquiring information indicating the intensity distribution of the reflection light using the dome lighting source 38, the orientation state of the luster material included in the object W can be estimated without rotating the object W. Examples of the dome lighting source 38 include a flat dome lighting source, a ring lighting source, and the like.

The dome lighting source 38 does not emit light sequentially from different directions, but rather emits light simultaneously from different directions. Therefore, control section 2 cannot calculate the FI value, and extracts the Lab value instead of the FI value for each pixel. Here, the L-value is extracted for each pixel.

In addition, in a case where the first FI value is acquired, since it is necessary to acquire the multi-angle spectroscopic images, as illustrated in FIG. 9, the dome lighting source 38 may be retracted. By this, it is possible to prevent the dome lighting source 38 from obstructing the capturing of the multi-angle spectroscopic images.

### 3.2. Method of Displaying Spectral Measurement Results

Next, the method of displaying spectral measurement results according to the third embodiment will be described.

The method of displaying spectral measurement results according to the third embodiment is the same as the method of displaying spectral measurement results according to the second embodiment except that the L-value is used instead of the second FI value.

In the present embodiment, in the second spectroscopic image acquisition step S106b, the lighting sources 321, 322, and 323 are turned off, and the dome lighting source 38 is turned on. Then, reflection light from the dome lighting source 38 is imaged by the spectrographic camera 36. By this, a spectroscopic image is acquired.

In the second FI value distribution information generation step S108b, L-value distribution information is generated based on the spectroscopic image.

In the FI value distribution difference information generation step S116, the difference between the first FI value and the L-value is calculated for each pixel, and the FI value distribution difference information representing the distribution of the difference is generated. The obtained FI value distribution difference information is useful for accurate evaluation of the distribution of the orientation state of the luster material, as in the second embodiment.

Also, in the third embodiment as described above, the same effects as those of the first, second embodiment can be obtained.

In the third embodiment, by using the dome lighting source 38, the FI value distribution difference information can be generated without performing the rotation operation of the object W by the rotary table 4. Therefore, it is possible to simplify the configuration of the spectrometer 1 and to simplify the operation in the method of displaying spectral measurement results.

Some of the steps described above may be omitted or may be replaced with steps having the same configuration. The order of the steps may be changed.

### 4. Fourth Embodiment

Next, a method of displaying spectral measurement results according to a fourth embodiment will be described.

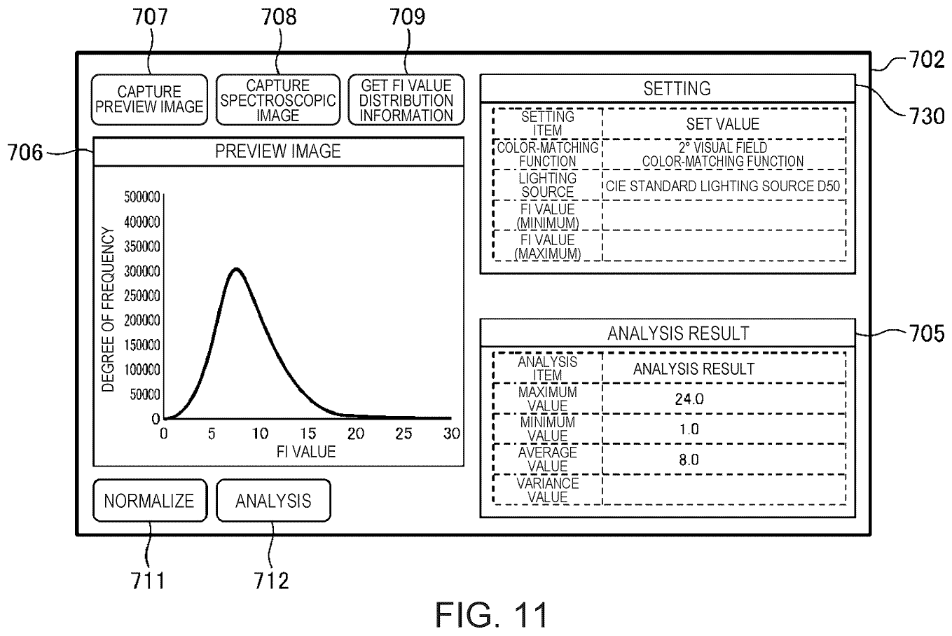

FIG. 11 is an example of the display screen 702 displayed in the FI value distribution information display step S110 included in the method of displaying spectral measurement results according to the fourth embodiment.

Hereinafter, the fourth embodiment will be described. In the following description, differences from the first embodiment will be mainly described, and the description of the same matters will be omitted. In FIG. 11, the same components as those in FIG. 6 are denoted by the same reference numerals.

The fourth embodiment is the same as the first embodiment except that an FI histogram 706 is adopted as visualized FI value distribution information.

The display screen 702 shown in FIG. 11 includes the FI histogram 706. The FI histogram 706 shown in FIG. 11 is a histogram obtained by graphing the frequency of the FI value for each bin. By generating such the FI histogram 706 and displaying it on the display section 54, it becomes easy for the user to intuitively understand the distribution state of the metallic feel on the measurement surface W1. In particular, according to the FI histogram 706, it is easy to understand the distribution state of the metallic feel from the viewpoint of the number of pixels for each FI value rather than the two-dimensional distribution. By this, it is possible to accurately evaluate the degree of unevenness of the metallic feel on the measurement surface W1.

By performing the normalization process on the FI histogram 706, it is possible to increase the resolution of the degree of frequency in the FI histogram 706. By this, the evaluation can be performed more accurately using the FI histogram 706.

Furthermore, by generating the FI histogram 706, it is possible to more easily compare the measurement data with the reference data.

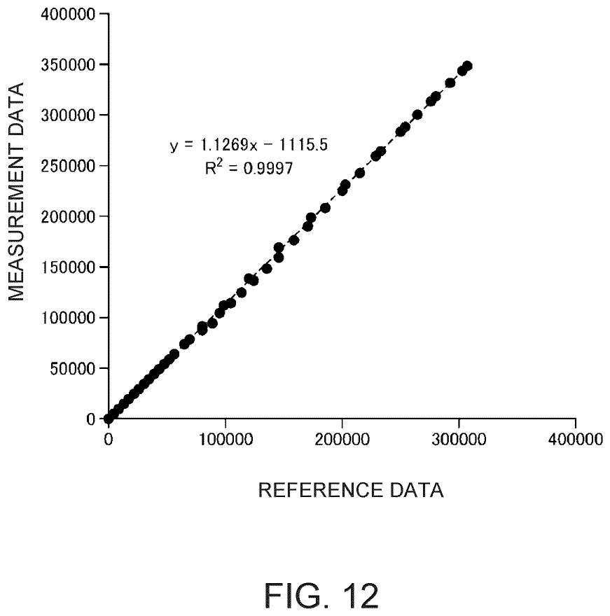

FIG. 12 is a graph showing an example of the result of the data comparison processing. The graph shown in FIG. 12 is a scatter diagram obtained by plotting the ratio of the measurement data to the reference data, and a regression line obtained by linearly approximating the plot marks. The measurement data is a value of a degree of frequency based on the FI histogram 706, and the reference data is a value of a degree of frequency serving as a comparison reference classified into the same bin as the measurement data. Then, the ratio of the measurement data to the reference data is calculated for each bin, and the scatter diagram shown in FIG. 12 is obtained by plotting the ratios. FIG. 12 also shows the equation of the regression line and the coefficient of determination R2. In the equation of the regression line, the value of the vertical axis is y, and the value of the horizontal axis is x. The coefficient of x is the correlation coefficient of the measured data with respect to the reference data. The closer the correlation coefficient is to 1, the stronger the correlation between the two, that is, the closer the measured data is to the reference data. The coefficient of determination represents the degree of approximation by the regression line. By performing such a data comparison process, it is possible to inspect the measurement data based on the reference data.

Also in the fourth embodiment as described above, the same effects as in the first embodiment can be obtained.

Some of the steps described above may be omitted or may be replaced with steps having the same configuration. The order of the steps may be changed.

### 5. Effects of the Above Embodiment

As described above, the spectrometer 1 according to these embodiments includes the spectroscopic measurement section 3 and the FI value processing section 206. The spectroscopic measurement section 3 performs multi-angle spectroscopic measurements on the measurement surface W1 of the object Wand acquires multi-angle spectroscopic images. The FI value processing section 206 calculates the FI value for each region of the multi-angle spectroscopic images and generates FI value distribution information indicating the distribution of FI values.

According to such a configuration, it is possible to obtain the spectrometer 1 capable of easily evaluating the distribution state of the metallic feel on the measurement surface W1. Since it is possible to associate a region such as a pixel with an FI value, it is possible to obtain the spectrometer 1 capable of evaluating the distribution state of the metallic feel with high positional accuracy.

The spectroscopic measurement section 3 may include the multi-angle lighting source 32 and the spectrographic camera 36. The multi-angle lighting source 32 irradiates the measurement surface W1 with light from different directions. The spectrographic camera 36 spectrally disperses and images the measurement surface W1 irradiated with light from the multi-angle lighting source 32.

According to such a configuration, it is possible to obtain the spectrometer 1 capable of more accurately and quickly evaluating the distribution state of the metallic feel of the measurement surface W1.

The spectroscopic measurement section 3 may include the dome lighting source 38 that irradiates the measurement surface W1 with light.

According to such a configuration, by using the dome lighting source 38, it is possible to simultaneously irradiate light from different directions. Therefore, the orientation state of the luster material contained in the object W can be estimated without rotating the object W. By this, it is possible to simplify the configuration of the spectrometer 1 and to simplify the operation in the method of displaying spectral measurement results.

In addition, the spectrometer 1 according to the above-described embodiment includes the display control section 210. The display control section 210 displays the visualized FI value distribution information on the display section 54.

According to such a configuration, it becomes easy for the user to intuitively understand the distribution state of the metallic feel on the measurement surface W1. As a result, it is possible to accurately evaluate the degree of unevenness of the metallic feel on the measurement surface W1.

Preferably, the regions of the multi-angle spectroscopic images are pixels of the multi-angle spectroscopic images.

According to such a configuration, it is possible to obtain the spectrometer 1 that enables evaluating the distribution state of the metallic feel with high positional accuracy.

The visualized FI value distribution information may be the FI image obtained by converting the FI value into luminance.

According to such a configuration, it becomes easy for the user to intuitively understand the distribution state of the metallic feel on the measurement surface W1. As a result, it is possible to accurately evaluate the degree of unevenness of the metallic feel on the measurement surface W1.

The visualized FI value distribution information may be the FI histogram obtained by counting and graphing the degree of frequency of the FI value for each bin.

According to such a configuration, it becomes easy for the user to intuitively understand the distribution state of the metallic feel on the measurement surface W1. In particular, from the viewpoint of the number of pixels for each FI value, the distribution state of the metallic feel is easily understood. By this, it is possible to accurately evaluate the degree of unevenness of the metallic feel on the measurement surface W1.

In addition, the spectrometer 1 according to the above-described embodiment includes the rotary table 4 that rotates the target object W in a plane including the measurement surface W1.

According to such a configuration, the object W can be easily rotated.

The method of displaying spectral measurement results according to the above-described embodiment includes the spectroscopic image acquisition step S106, the FI value distribution information generation step S108, and the FI value distribution information display step S110.

In the spectroscopic image acquisition step S106, the measurement surface W1 of the object W is sequentially irradiated with light from a plurality of directions different from each other, and the measurement surface W1 irradiated with the light is spectrally dispersed and sequentially imaged by the spectrographic camera 36 to acquire multi-angle spectroscopic images. In the FI value distribution information generation step S108, the FI value of multi-angle spectroscopic images are calculated for each region, and FI value distribution information representing the distribution of the FI value is generated. In the FI value distribution information display step S110, FI value distribution information is visualized and displayed.

According to such a configuration, it is possible to easily evaluate the distribution state of the metallic feel on the measurement surface W1. Since it is possible to associate the regions such as the pixels with the FI value, it is possible to evaluate the distribution state of the metallic feel with high positional accuracy.

It is preferable that the FI value distribution information generation step S108 (the step of generating FI value distribution information) includes a process of calculating the FI value for each pixel of the multi-angle spectroscopic images.

According to such a configuration, the distribution state of the metallic feel can be evaluated with high positional accuracy.

The method of displaying spectral measurement results according to the above-described embodiment includes the first spectroscopic image acquisition step S106a, the object rotation step S107, the second spectroscopic image acquisition step S106b, the first FI value distribution information generation step S108a, the second FI value distribution information generation step S108b, the FI value distribution difference information generation step S116, and the FI value distribution difference information display step S118.

In the first spectroscopic image acquisition step S106a, the measurement surface W1 of the object W is sequentially irradiated with light from a plurality of directions different from each other, the measurement surface W1 irradiated with the light is spectrally dispersed and sequentially imaged by the spectrographic camera 36, and a first multi-angle spectroscopic image is acquired. In the object rotation step S107, the relative orientation of the object W with respect to the irradiation direction of the light and the position of the spectrographic camera 36 is rotated by 180° in the plane including the measurement surface W1. In the second spectroscopic image acquisition step S106b, the measurement surface W1 after the rotation of the object W is sequentially irradiated with light from a plurality of directions different from each other, and the measurement surface W1 irradiated with the light is spectrally dispersed and sequentially imaged by the spectrographic camera 36 to acquire a second multi-angle spectroscopic image. In the first FI value distribution information generation step S108a, the first FI value is calculated for each region of the first multi-angle spectroscopic image to generate the first FI value distribution information. In the second FI value distribution information generation step S108b, the second FI value is calculated for each region of the multi-angle spectroscopic images to generate the second FI value distribution information. In the FI value distribution difference information generation step S116, the difference between the first FI value and the second FI value is calculated for each region, and the FI value distribution difference information representing the distribution of the difference is generated. In the FI value distribution difference information display step S118, FI value distribution difference information is visualized and displayed.

According to such a configuration, it is possible to easily evaluate the distribution state of the metallic feel on the measurement surface W1. Since it is possible to associate the regions such as the pixels with the FI value, it is possible to evaluate the distribution state of the metallic feel with high positional accuracy. Further, it is possible to accurately evaluate the distribution of the orientation state of the luster material included in the object W.

Although the spectrometer and the method of displaying spectral measurement results according to the present disclosure have been described based on the embodiments shown in the drawings, the present disclosure is not limited thereto.

For example, the spectrometer according to the present disclosure may be a device in which each section of the embodiment is replaced with an arbitrary configuration having the same function and may be a device in which an arbitrary configuration is added to the embodiment. The method of displaying spectral measurement results according to the present disclosure may be a method in which a process for an arbitrary purpose is added to the embodiment.

1. A spectrometer comprising:
a spectroscopic measurement section configured to perform multi-angle spectroscopic measurements on a measurement surface of an object and acquire multi-angle spectroscopic images and
an FI value processing section that calculates an FI value for each region of the multi-angle spectroscopic images and generates FI value distribution information indicating a distribution of the FI values.

2. The spectrometer according to claim 1, wherein
the spectroscopic measurement section includes
a multi-angle lighting source that irradiates the measurement surface with light from directions different from each other and
a spectrographic camera for spectrally dispersing and imaging the measurement surface irradiated with the light from the multi-angle lighting source.

3. The spectrometer according to claim 2, wherein
the spectroscopic measurement section includes a dome lighting source that irradiates the measurement surface with light.

4. The spectrometer according to claim 1, further comprising:
a display control section configured to display the visualized FI value distribution information on a display section.

5. The spectrometer according to claim 1, wherein
the regions of the multi-angle spectroscopic images are pixels of the multi-angle spectroscopic images.

6. The spectrometer according to claim 1, wherein
the visualized FI value distribution information is an FI image obtained by converting the FI value into luminance.

7. The spectrometer according to claim 1, wherein
the visualized FI value distribution information is an FI histogram obtained by counting and graphing the frequency of the FI value for each bin.

8. The spectrometer according to claim 1, further comprising:
a rotary table configured to rotate the object in a plane including the measurement surface.

9. A method of displaying spectral measurement results, the method comprising:
sequentially irradiating a measurement surface of an object with light from a plurality of different directions, sequentially imaging the measurement surface irradiated with the light by spectrally dispersing the light with a spectrographic camera, and acquiring multi-angle spectroscopic images;
calculating an FI value of the multi-angle spectroscopic images for each region and generating FI value distribution information indicating a distribution of the FI value; and
visualizing and displaying the FI value distribution information.

10. The method of displaying spectral measurement results, the method according to claim 9, wherein
generating FI value distribution information includes calculating the FI value for each pixel of the multi-angle spectroscopic image.

11. A method of displaying spectral measurement results, the method comprising:
sequentially irradiating a measurement surface of an object with light from a plurality of different directions, sequentially imaging the measurement surface irradiated with the light by spectrally dispersing the light with a spectrographic camera, and acquiring first multi-angle spectroscopic images;
rotating a relative orientation of the object with respect to an irradiation direction of the light and a position of the spectrographic camera by 180° in a plane having the measurement surface;
sequentially irradiating the measurement surface of the object after rotation with light from a plurality of different directions, sequentially imaging the measurement surface irradiated with the light by spectrally dispersing the light with the spectrographic camera, and acquiring second multi-angle spectroscopic images;
calculating a first FI value for each region of the first multi-angle spectroscopic images and generating first FI value distribution information;
calculating a second FI value for each of the region of the second multi-angle spectroscopic images and generating second FI value distribution information;
calculating differences between the first FI value and the second FI value for each region and generating FI value distribution difference information indicating a distribution of the differences; and
visualizing and displaying the FI value distribution difference information.
